(19) United States
(12) Patent Application Publication
(10) Pub. No.: US 2005/0265217 A1
(43) Pub. Date: Dec. 1, 2005

(54) Optical recording medium and information recording/playback apparatus

(75) Inventor: Yasuaki Ootera, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/138,916

(22) Filed: May 27, 2005

(30) Foreign Application Priority Data
May 31, 2004 (JP) 2004-162116

(51) Int. Cl. G11B 7/26; G11B 7/24

(52) U.S. Cl. 369/283; 369/275.1; 369/275.5; 369/272.1

(57) ABSTRACT

In an example of the present invention, an optical recording medium includes the first substrate on a light beam incident surface side, the second substrate on an opposite side to the light beam incident surface side, the first recording layer which is arranged between the first and second substrates, the first reflecting layer which is arranged between the first recording layer and the second substrate, an adhesive layer which is arranged between the first reflecting layer and the second substrate, the second recording layer which is directly arranged on the adhesive layer, and the second reflecting layer which is arranged between the second recording layer and the second substrate, wherein the adhesive layer is made of an ultraviolet curing resin having a glass transition temperature of 80 to 160° C.

### CROSS-REFERENCE TO RELATED APPLICATIONS

This application is based upon and claims the benefit of priority from prior Japanese Patent Application No. 2004-162116, filed May 31, 2004, the entire contents of which are incorporated herein by reference.

### BACKGROUND OF THE INVENTION

1. Field of the Invention

The present invention relates to an optical recording medium which forms a recording mark when irradiated with a light beam. The present invention also relates to an information recording/playback apparatus which records information on this optical recording medium, and plays back the information recorded on the optical recording medium.

2. Description of the Related Art

In recent years, various optical discs have been introduced, and research and development of the various optical discs has been pursued. In Jpn. Pat. Appln. KOKAI Publication No. 2003-59108 (claim 7, FIG. 1), a WORM optical recording medium has been proposed, which includes a reflecting layer made of a low-melting-point metal material on a molded substrate, a recording layer formed on the reflecting layer by mainly using an organic dye for absorbing light to undergo a change in properties, and a cover layer on the recording layer. That is, the WORM optical recording medium has been proposed, in which a laser beam enters from the opposite surface of a general optical recording medium to perform recording/playback. Therefore, it is assumed that preferable recording/playback can be performed even in the WORM optical recording medium in which the laser beam enters from the opposite surface of the general optical recording medium.

However, in the WORM optical recording medium disclosed in the above reference, the organic dye is not in contact with the molded substrate. Hence, in this WORM optical recording medium, a general recording mark molding process in which the molded substrate deforms by the dissolution of the organic dye to form the recording mark cannot be implemented. That is, this WORM optical recording medium cannot be applied to, e.g., the L1 layer of a Blu-ray disc, two-layered HD, or DVD-R.

In the above reference, a reflecting film between the organic dye and the molded substrate is made of a low-melting (600° C. or lower) material which is easily dissolved and deformed by heating when recording information. However, actually, a playback signal quality equivalent to that of the conventional medium cannot be obtained only by deforming the low-melting reflecting film material. In addition, since materials to be used in the reflecting film are strictly limited, no material satisfying characteristics such as high reflectance and low noise is available, thus posing a problem.

### BRIEF SUMMARY OF THE INVENTION

In an aspect of the present invention, an optical recording medium comprises a first substrate which is positioned on a light beam incident surface side, a second substrate which is positioned on an opposite side to the light beam incident surface side, a first recording layer which is arranged between the first substrate and the second substrate and undergoes a change in properties when irradiated with a laser beam, a first reflecting layer which is arranged between the first recording layer and the second substrate, an adhesive layer which is arranged between the first reflecting layer and the second substrate and deforms when irradiated with the laser beam, a second recording layer which is directly arranged on the adhesive layer between the adhesive layer and the second substrate and undergoes a change in properties when irradiated with the laser beam, and a second reflecting layer which is arranged between the second recording layer and the second substrate, wherein the adhesive layer essentially consists of an ultraviolet curing resin having a glass transition temperature of 80 to 160° C.

In another aspect of the present invention, an optical recording medium comprises a cover sheet which is positioned on a light beam incident surface side, a substrate which is positioned on an opposite side to the light beam incident surface side, an adhesive layer which is arranged between the cover sheet and the substrate and deforms when irradiated with a laser beam, a recording layer which is directly arranged on the adhesive layer between the adhesive layer and the substrate and undergoes a change in properties when irradiated with the laser beam, and a reflecting layer which is arranged between the recording layer and the substrate, wherein the recording layer is directly arranged on the adhesive layer, and the adhesive layer essentially consists of an ultraviolet curing resin having a glass transition temperature of 80 to 160° C.

In still another aspect of the present invention, an information recording/playback apparatus which emits light beam on an optical recording medium which includes a first substrate which is positioned on a light beam incident surface side, a second substrate which is positioned on an opposite side to the light beam incident surface side, a first recording layer which is arranged between the first substrate and the second substrate and undergoes a change in properties when irradiated with a laser beam, a first reflecting layer which is arranged between the first recording layer and the second substrate, an adhesive layer which is arranged between the first reflecting layer and the second substrate and deforms when irradiated with the laser beam, a second recording layer which is directly arranged on the adhesive layer between the adhesive layer and the second substrate and undergoes a change in properties when irradiated with the laser beam, and a second reflecting layer which is arranged between the second recording layer and the second substrate, wherein the adhesive layer essentially consists of an ultraviolet curing resin having a glass transition temperature of 80 to 160° C., records the information on the optical recording medium, the information recording/playback apparatus playing back the information recorded on the optical recording medium, comprises a control unit configured to control the light beam irradiation in correspondence with recorded data, and a recording unit configured to emit the light beam on the optical recording medium and forms a recording mark by deforming the adhesive layer, on the basis of the control of the light beam irradiation by the control unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view of a two-layered WORM optical disc (optical recording medium) according to a first embodiment of the present invention;

FIG. 2 is a view showing an example of the flow of a manufacturing method in the two-layered WORM optical disc;

FIG. 3 is a view showing an example of the characteristics of an ultraviolet curing resin applied to the two-layered WORM optical disc;

FIG. 4 is a sectional view of a single-layered WORM optical disc (optical recording medium) according to a second embodiment of the present invention; and

FIG. 5 is a block diagram showing an example of a schematic arrangement of an information recording/ playback apparatus which records information on the two-layered and single-layered WORM optical discs, and plays back the information recorded on these optical discs.

### DETAILED DESCRIPTION OF THE INVENTION

Embodiments of the present invention will be described below with reference to the accompanying drawing.

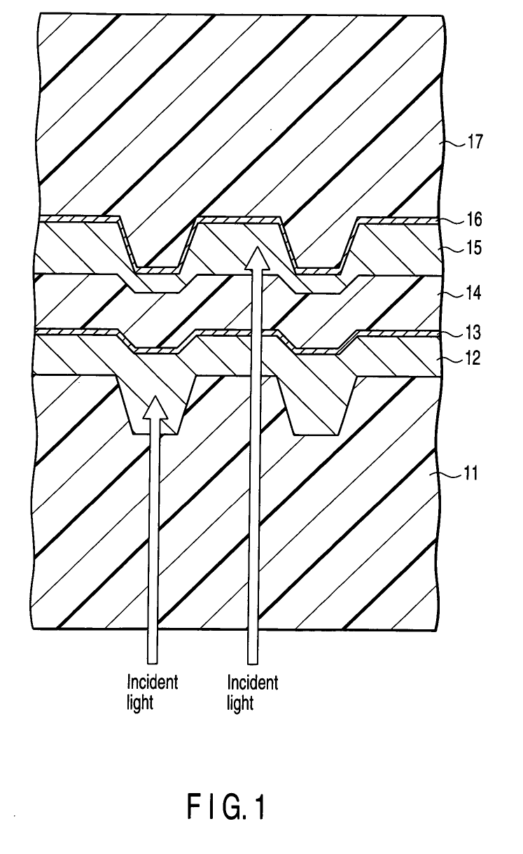

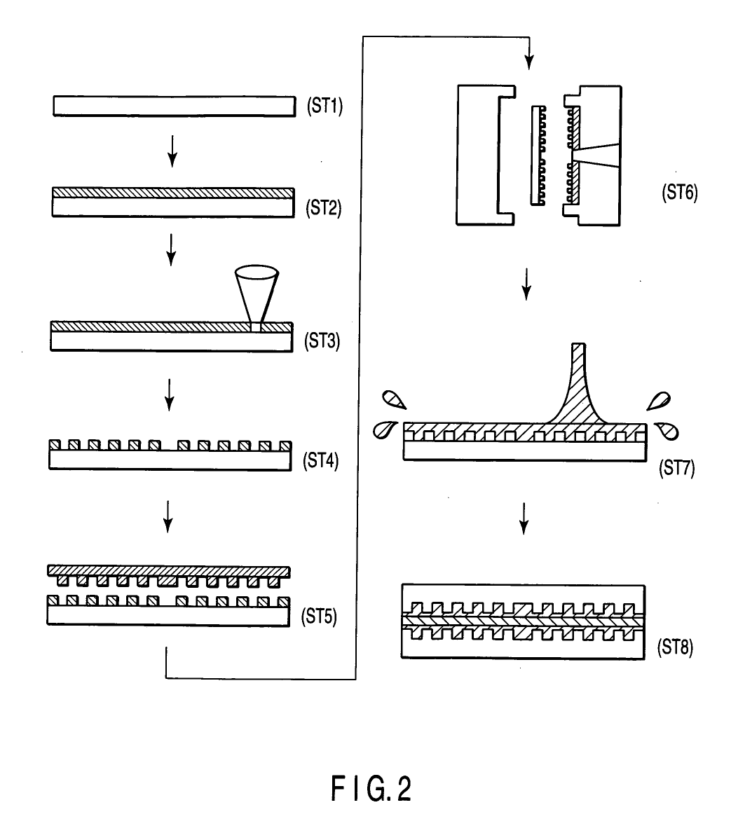

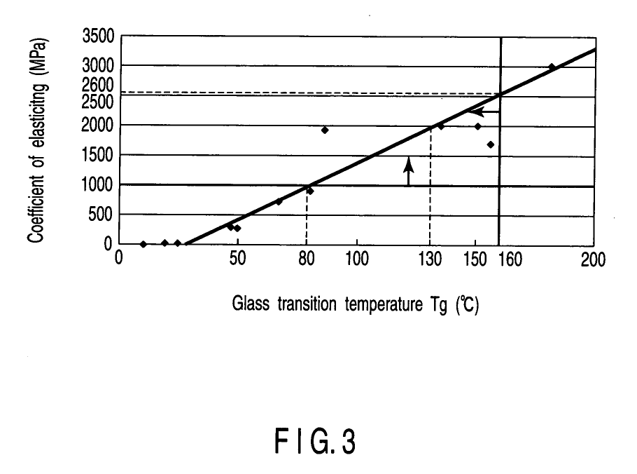

FIG. 1 is a sectional view of a two-layered WORM optical disc (optical recording medium) according to the first embodiment of the present invention. FIG. 2 is a view showing the flow of a manufacturing method for this WORM optical disc. FIG. 3 is a view showing the characteristic range of an ultraviolet curing resin to be applied to this WORM optical disc.

As shown in FIG. 1, the two-layered WORM optical disc includes a molded substrate 11 which is positioned on a light beam incident surface side, a molded substrate 17 which is positioned on the side opposite to the light beam incident surface side, a recording layer 12 which is arranged between the molded substrates 11 and 17 and undergoes a change in properties when irradiated with a laser beam, a reflecting layer 13 which is arranged between the recording layer 12 and the molded substrate 17, an adhesive layer 14 which is arranged between the reflecting layer 13 and the molded substrate 17 and deforms when irradiated with the laser beam, a recording layer 15 which is directly arranged on the adhesive layer 14 between the adhesive layer 14 and the molded substrate 17 and undergoes a change in properties when irradiated with the laser beam, and a reflecting layer 16 which is arranged between the recording layer 15 and the molded substrate 17.

The molded substrate 11 on the light incident side has a tracking groove and a prepit on which disc information and the like are recorded. The recording layer 12 is arranged in the groove of the molded substrate 11. This recording layer 12 is a layer using an organic dye which undergoes a change in properties when irradiated with light. A peripheral groove deforms by this change in properties to form a mark, and record the information. A diazo organic dye material or phthalocyanine organic dye material is used in the recording layer 12. On the recording layer 12, for example, the reflecting layer 13 made of Al or Ag is formed by sputtering or the like. As described above, a first layer L0 includes the molded substrate 11, recording layer 12, and reflecting layer 13.

Similarly, the molded substrate 17 on the opposite side to the light incident side also has the tracking groove and the prepit on which the disc information and the like are recorded. The recording layer 12 is arranged in the groove of the molded substrate 17 through the reflecting layer 16. This recording layer 12 is a layer using the organic dye which undergoes a change in properties when irradiated with light. The peripheral groove deforms by this change in properties to form the mark, thereby recording the information. The diazo organic dye material or phthalocyanine organic dye material is used in the recording layer 12. As described above, a second layer L1 includes the molded substrate 17, reflecting layer 16, and recording layer 15. That is, the arrangement order in the second layer L1 is different from that in the first layer L0.

One optical disc is formed by adhering the first and second layers L0 and L1 through the adhesive layer 14.

In the first embodiment, assume that a disc has a diameter of 120 mm and a thickness of 1.2 mm (adhering two layers including a polycarbonate molded substrates each having a thickness of 0.6 mm), and this disc serves as the WORM optical disc. Of course, the disc in the present invention is not limited to these numerical values. For example, as recording/playback light applied to the disc in the first embodiment, recording/playback light having a wavelength of 400 nm is used. As an optical objective lens which processes this recording/playback light, a lens having a numerical aperture of 0.65 is used. Also, in the disc according to the first embodiment, the track pitch between the grooves becomes 400 nm. However, the disc of the present invention is not limited to these numerical values.

The manufacturing method of the above two-layered WORM optical disc will now be described below with reference to FIG. 2. A master is made of glass, and has a surface which is polished and cleaned (ST1). A photoresist is applied to the surface of the master (ST2), and the photoresist surface is exposed to the laser beam and the like to record the information (ST3). Next, the exposed master is developed to form convex and concave portions such as the pits and groove (ST4). After that, the master is plated, and then a stamper (generally made of nickel) is formed (ST5). By using the stamper as a mold, the molded substrate 11 made of a resin (generally made of polycarbonate) is formed by injecting molding (ST6). The organic dye is applied by spin coating as the recording layer 12 on the above-described molded substrate 11 (ST7). The reflecting layer 13 is formed on the recording layer 12 of the organic dye. As described above, the first layer L0 is formed. Similarly, the molded substrate 17 is formed (ST6), the reflecting layer 16 is formed on this molded substrate 17, and the organic dye is applied by spin coating as the recording layer 15 on the reflecting layer 16 (ST7). As described above, the second layer L2 is formed. These first and second layers L0 and Ll are adhered through the adhesive layer 14. With this operation, the two-layered WORM optical disc is completely formed (ST8).

The recording principle of the WORM optical disc using the organic dye will be described below. For example, the recording laser beam having a wavelength of 400 nm is applied to the organic dye filled in the groove of the molded substrate. This organic dye which initiates a chemical reaction deforms the adjacent molded substrate by reaction heat, to form a recording mark. This is the recording principle of the general WORM optical disc.

However, in the two-layered WORM disc, the metal reflecting layer 16 is arranged between the organic dye (recording layer 15) serving as the inner second layer L1 and the molded substrate 17. Hence, the reaction heat from the organic dye (recording layer 15) escapes through the metal reflecting layer 16. Hence, a preferable recording mark cannot be formed on the molded substrate 17.

With this arrangement, in the two-layered WORM disc of the present invention, the adhesive layer 14 which is in direct contact with the organic dye (recording layer 15) of the second layer L1 deforms in place of the molded substrate 17. As a result, a higher-quality recording mark is formed.

Preferably, the adhesive layer 14 made of the ultraviolet curing resin is easily deformed by the reaction heat from the organic dye (recording layer 15). Hence, in the present invention, the adhesive layer 14 consists of the ultraviolet curing resin having a glass transition temperature of 80 to 160° C.

If the molded substrate 17 is made of a polycarbonate resin having a glass transition temperature of 150° C. (about 135 to 155° C.), more preferably, the adhesive layer 14 is made of an ultraviolet curing resin having a glass transition temperature of 80 to 130° C. which is lower than that of the polycarbonate resin.

Note that the glass transition point and elastic coefficient of the ultraviolet curing resin contained in the adhesive layer 14 correlate with each other, as shown in FIG. 3. When using the adhesive layer 14 having a low glass transition point, a material (flexible material) having a low coefficient of elasticity is used as the adhesive layer 14. When using a material having a low coefficient of elasticity as the adhesive layer 14, the adhesive layer 14 flows when forming the recording mark. This flow affects the adjacent mark, i.e., increases cross write and cross erase. This phenomenon becomes more conspicuous when the organic dye (recording layer 15) is in direct contact with the adhesive layer 14. In order to avoid this problem, the coefficient of elasticity of the adhesive layer 14 is desirably set to 1,000 to 2,600 MPa. That is, the adhesive layer 14 is desirably inflexible to some degree. More preferably, the coefficient of elasticity the adhesive layer 14 is set to 1,000 to 2,000 MPa.

Therefore, since an ultraviolet curing resin having a glass transition temperature of 160° C. or lower, and the coefficient of elasticity of 1,000 MPa or higher is used as the adhesive layer 14, the single-sided/two-layered WORM optical disc with optimal recording characteristics can be provided.

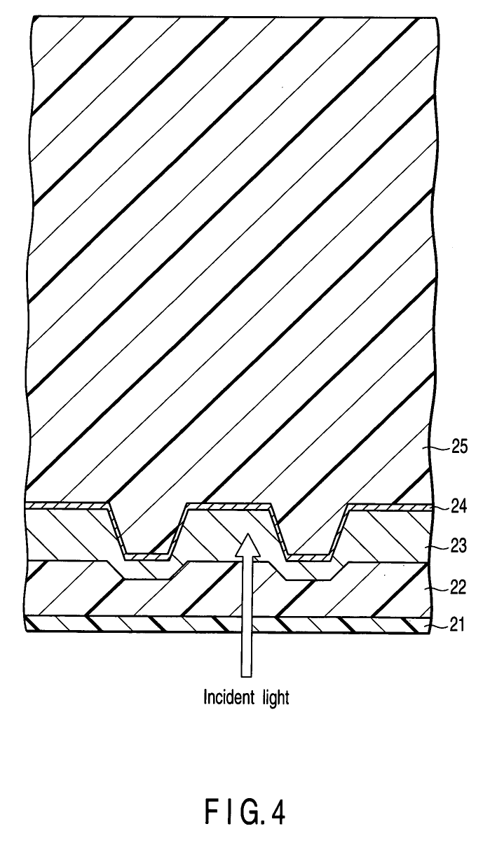

Next, with reference to FIG. 4, a single-layered WORM optical disc (optical recording medium) according to a second embodiment of the present invention will be described. In the first embodiment, the arrangement of the disc layer of the present invention is applied to the two-layered WORM optical disc. However, in the second embodiment, the layer arrangement of a disc of the present invention can also be applied to a single-layered WORM optical disc.

As shown in FIG. 4, the single-layered WORM optical disc includes a cover sheet 21 which is positioned on a light beam incident surface side, a molded substrate 25 which is positioned on the opposite side to the light beam incident surface side, an adhesive layer 22 which is arranged between the cover sheet 21 and the molded substrate 25 and deforms when irradiated with a laser beam, a recording layer 23 which is directly arranged on the adhesive layer 22 between the adhesive layer 22 and the molded substrate 25 and undergoes a change in properties when irradiated with the laser beam, and a reflecting layer 24 which is arranged between the recording layer 23 and the molded substrate 25.

In the first embodiment, the disc has a diameter of 120 mm, and a thickness of 1.2 mm (adhering two layers including polycarbonate molded substrates each having a thickness of 0.6 mm), and this disc serves as the WORM optical disc. In the second embodiment, similarly, a disc having a diameter of 120 mm and a thickness of 1.2 mm is used. However, the disc is formed by adhering a cover sheet having a thickness of 0.1 mm on a polycarbonate molded substrate having a thickness of 1.1 mm. For example, as recording/playback light applied to the disc in the second embodiment, recording/playback light having a wavelength of 400 nm is used. As an optical objective lens which processes this recording/playback light, a lens having a numerical aperture of 0.85 is used. The recording/playback light enters from the side of the cover sheet having the thickness of 0.1 mm.

In the disc of the second embodiment, as described above, the reflecting layer 24, recording layer 23, adhesive layer 22, and cover sheet 21 are sequentially stacked on the groove formed on the molded substrate 25. Therefore, the metal reflecting layer 24 is sandwiched between the organic dye (recording layer 23) and the molded substrate 25. That is, for the same reason as that described in the first embodiment, it is difficult to deform the molded substrate 25 to form a high-quality recording mark.

In the disc of the second embodiment, the adhesive layer 22 made of the ultraviolet curing resin easily deforms by the reaction heat from the organic dye (recording layer 23). Hence, the adhesive layer 22 consists of the ultraviolet curing resin having a glass transition temperature of 80 to 160° C.

If the molded substrate 25 is made of a polycarbonate resin having a glass transition temperature of 150° C., more preferably, the adhesive layer 22 is made of the ultraviolet curing resin having a glass transition temperature of 80 to 130° C. which is lower than that of the polycarbonate resin.

Note that the glass transition point and elastic coefficient of the ultraviolet curing resin contained in the adhesive layer 22 correlates with each other, as shown in FIG. 3. When using the adhesive layer 22 having a low glass transition point, a material (flexible material) having a low coefficient of elasticity is used as the adhesive layer 22. When using a material having a low coefficient of elasticity as the adhesive layer 22, the adhesive layer 22 flows when forming the recording mark. This flow affects the adjacent mark, i.e., increases cross write and cross erase. This phenomenon becomes more conspicuous when the organic dye (recording layer 23) is in direct contact with the adhesive layer 22. In order to avoid this problem, the coefficient of elasticity the adhesive layer 22 is desirably set to 1,000 to 2,600 MPa. That is, the adhesive layer 22 is desirably inflexible to some degree. More preferably, the coefficient of elasticity of the adhesive layer 22 is set to 1,000 to 2,000 MPa.

Therefore, since an ultraviolet curing resin having a glass transition temperature of 160° C. or lower, and the coefficient of elasticity of 1,000 MPa or higher is used as the adhesive layer 22, the single-sided/single-layered WORM optical disc with optimal recording characteristics can be provided.

As described above, since the ultraviolet curing resin having a glass transition point of 160° C. or lower is used as the adhesive layer 14 or 22, a high-quality recording mark can be formed on the disc in which the metal reflecting layer 16 or 24 is sandwiched between the organic dye (recording layer 15 or 23) and the molded substrate 17 or 25.

Since the ultraviolet curing resin having the coefficient of elasticity 1,000 MPa or higher is used as the adhesive layer 14 or 22 in the WORM optical disc, cross write and cross erase to the adjacent track can also be prevented in the disc in which the organic dye (recording layer 15 or 23) is in direct contact with the adhesive layer 14 or 22.

In the WORM optical recording medium in which the laser beam enters from the opposite surface of the general optical recording medium to record/play back the information, the mark cannot be formed because the reaction heat from the organic dye by the recording/ playback light is absorbed by the reflecting film and adhesive. However, when using the adhesive (adhesive layer) having the glass transition point of 160° C. or lower, a preferable mark can be formed because the adhesive (adhesive layer) deforms in place of the molded substrate. Note that, in this case, the coefficient of elasticity of the adhesive, which reaches a trade-off level of the glass transition point must have a value (hardness) of 1,000 MPa or higher in order to suppress the flow of the recording mark between the tracks.

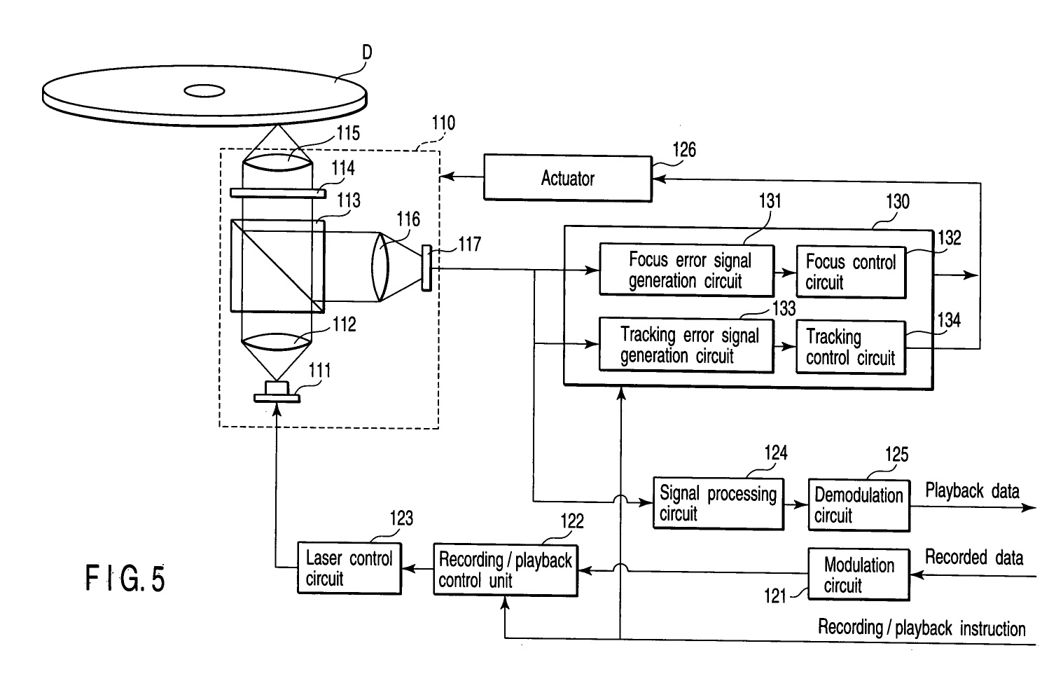

Referring to FIG. 5, an information recording/ playback apparatus which causes the laser beam to apply to the above two-layered and single-layered optical discs, records the information on these optical discs, and plays back the information recorded on the optical discs will be described below. FIG. 5 is a block diagram showing a schematic arrangement of the optical disc apparatus (information recording/playback apparatus) according to an example of the present invention.

As shown in FIG. 5, the optical disc apparatus includes an optical pickup 110, modulation circuit 121, recording/playback control unit 122, laser control circuit 123, signal processing circuit 124, demodulation circuit 125, actuator 126, and focus tracking control unit 130.

The optical pickup 110 also includes a laser 111, collimator lens 112, polarization beam splitter (PBS) 113, quarter wavelength plate 114, objective lens 115, focus lens 116, and photodetector 117.

The focus tracking control unit 130 also includes a focus error signal generation circuit 131, a focus control circuit 132, tracking error signal generation circuit 133, and tracking control circuit 134.

The operation of recording the information on an optical disc D (two-layered or single-layered WORM optical disc) in this optical disc apparatus will be described below. The modulation circuit 121 modulates recorded information (data symbol) from a host in accordance with a predetermined modulation method into a channel bit sequence. The channel bit sequence corresponding to the recorded information is input to the recording/playback control unit 122. Also, a recording/playback instruction (in this case, recording instruction) is output from the host to this recording/playback control unit 122. The recording/playback control unit 122 outputs a control signal to the actuator 126, and drives an optical pickup such that the light beam is appropriately focused on a target recording position. The recording/playback control unit 122 also supplies the channel bit sequence to the laser control circuit 123. The laser control circuit 123 converts the channel bit sequence into a laser driving waveform, and drives the laser 111. That is, the laser control circuit 123 pulse-drives the laser 111. In accordance with this operation, the laser 111 emits the recording light beam corresponding to the desired bit sequence. The recording light beam emitted from the laser 111 becomes parallel light by the collimator lens 112, and enters and passes through the PBS 113. The beam passing through the PBS 113 then passes through the quarter wavelength plate 114, and focused on the information recording surface of the optical disc D by the objective lens 115. The focused recording light beam is maintained in an optimal beam spot on the recording surface (recording layer 12 or 15) by focus control performed by the focus control circuit 132 and actuator 126, and the tracking control performed by the tracking control circuit 134 and actuator 126. Therefore, in the first layer LO of the disc D, the molded substrate 11 deforms to form the recording mark. Also, in the second layer L1 of the disc D, the adhesive layer 14 or 22 deforms to form a recording mark.

The operation of playing back the data from the optical disc D in this optical disc apparatus will be described below. A recording/playback instruction (in this case, playback instruction) is output from the host to the recording/playback control unit 122. The recording/playback control unit 122 outputs a playback control signal to the laser control circuit 123 in accordance with the playback instruction from the host. The laser control circuit 123 drives the laser 111 based on the playback control signal. In accordance with this operation, the laser 111 emits the playback light beam. The playback light beam emitted from the laser 111 becomes parallel light by the collimator lens 112, and enters and passes through the PBS 113. The light beam passing through the PBS 113 then passes through the quarter-wavelength plate 114, and focused on the information recording surface of the optical disc D by the objective lens 115. The focused playback light beam is maintained in an optimal beam spot on the recording surface by focus control performed by the focus control circuit 132 and actuator 126, and the tracking control performed by the tracking control circuit 134 and actuator 126. In this case, the playback light beam emitted on the optical disc D is reflected by the reflecting layer. Reflected light passes through the objective lens 115 in the opposite direction, and becomes parallel light again. The reflected light then passes through the quarter-wavelength plate 114, has vertical polarization with respect to incident light, and is reflected by the PBS 113. The beam reflected by the PBS 113 becomes convergent light by the focus lens 116, and enters the photodetector 117. The photodetector 117 has, e.g., four photodetectors. The light beam which becomes incident on the photodetector 117 is photoelectrically converted into an electrical signal and amplified. The amplified signal is equalized and binarized by the signal processing circuit 124 and sent to the demodulation circuit 125. The demodulation circuit 125 executes a demodulation operation corresponding to a predetermined modulation method and outputs playback data.

On the basis of part of the electrical signal output from the photodetector 117, the focus error signal generation circuit 131 generates a focus error signal. Similarly, on the basis of part of the electrical signal output from the photodetector 117, the tracking error signal generation circuit 133 generates a tracking error signal. The focus control circuit 132 controls the actuator 128 and the focus of the beam spot, on the basis of the focus error signal. The tracking control circuit 134 controls the actuator 128 and the tracking of the beam spot, on the basis of the tracking error signal.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An optical recording medium which forms a recording mark when irradiated with a light beam, comprising:
a first substrate which is positioned on a light beam incident surface side;
a second substrate which is positioned on an opposite side to the light beam incident surface side;
a first recording layer which is arranged between the first substrate and the second substrate and undergoes a change in properties when irradiated with a laser beam;
a first reflecting layer which is arranged between the first recording layer and the second substrate;
an adhesive layer which is arranged between the first reflecting layer and the second substrate and deforms when irradiated with the laser beam;
a second recording layer which is directly arranged on the adhesive layer between the adhesive layer and the second substrate and undergoes a change in properties when irradiated with the laser beam; and
a second reflecting layer which is arranged between the second recording layer and the second substrate;
wherein the adhesive layer essentially consists of an ultraviolet curing resin having a glass transition temperature of 80 to 160° C.

2. A medium according to claim 1, wherein
the second substrate essentially consists of a polycarbonate resin having a glass transition temperature of 135 to 155° C., and
the adhesive layer essentially consists of an ultraviolet curing resin having a glass transition temperature of 80 to 130° C. which is lower than the glass transition temperature of the polycarbonate resin contained in the first substrate and the second substrate.

3. A medium according to claim 1, wherein
the adhesive layer essentially consists of an ultraviolet curing resin having a coefficient of elasticity of 1,000 to 2,600 MPa.

4. A medium according to claim 1, wherein
the adhesive layer essentially consists of an ultraviolet curing resin having a coefficient of elasticity of 1,000 to 2,000 MPa.

5. An optical recording medium which forms a recording mark when irradiated with a light beam, comprising:
a cover sheet which is positioned on a light beam incident surface side;
a substrate which is positioned on an opposite side to the light beam incident surface side;
an adhesive layer which is arranged between the cover sheet and the substrate and deforms when irradiated with a laser beam;
a recording layer which is directly arranged on the adhesive layer between the adhesive layer and the substrate, and undergoes a change in properties when irradiated with the laser beam; and
a reflecting layer which is arranged between the recording layer and the substrate;
wherein the recording layer is directly arranged on the adhesive layer and the adhesive layer consists of an ultraviolet curing resin having a glass transition temperature of 80 to 160° C.

6. A medium according to claim 5, wherein
the substrate essentially consists of a polycarbonate resin having a glass transition temperature of 135 to 155° C., and
the adhesive layer essentially consists of an ultraviolet curing resin having a glass transition temperature of 80 to 130° C. which is lower than the glass transition temperature of the polycarbonate resin contained in the substrate.

7. A medium according to claim 5, wherein
the adhesive layer essentially consists of an ultraviolet curing resin having a coefficient of elasticity of 1,000 MPa to 2,600 MPa.

8. A medium according to claim 5, wherein
the adhesive layer essentially consists of the ultraviolet curing resin having a coefficient of elasticity of 1,000 to 2,000 MPa.

9. An information recording/playback apparatus which emits light beam on an optical recording medium which includes a first substrate which is positioned on a light beam incident surface side, a second substrate which is positioned on an opposite side to the light beam incident surface side, a first recording layer which is arranged between the first substrate and the second substrate and undergoes a change in properties when irradiated with a laser beam, a first reflecting layer which is arranged between the first recording layer and the second substrate, an adhesive layer which is arranged between the first reflecting layer and the second substrate and deforms when irradiated with the laser beam, a second recording layer which is directly arranged on the adhesive layer between the adhesive layer and the second substrate and undergoes a change in properties when irradiated with the laser beam, and a second reflecting layer which is arranged between the second recording layer and the second substrate, wherein the adhesive layer essentially consists of an ultraviolet curing resin having a glass transition temperature of 80 to 160° C., records the information on the optical recording medium, the information recording/playback apparatus playing back the information recorded on the optical recording medium, comprising:
a control unit configured to control the light beam irradiation in correspondence with recorded data; and
a recording unit configured to emit the light beam on the optical recording medium and forms a recording mark by deforming the adhesive layer, on the basis of the control of the light beam irradiation by the control unit.
